(19) United States
(12) Patent Application Publication
(10) Pub. No.: US 2011/0069021 A1
(43) Pub. Date: Mar. 24, 2011

(54) REDUCING FALSE TOUCHPAD DATA BY IGNORING INPUT WHEN AREA GESTURE DOES NOT BEHAVE AS PREDICTED

(76) Inventor: Jared C. Hill, Castle Rock, CO (US)

(21) Appl. No.: 12/815,104

(22) Filed: Jun. 14, 2010

Related U.S. Application Data
(60) Provisional application No. 61/186,787, filed on Jun. 12, 2009.

(51) Int. Cl. G06F 3/041

(52) U.S. Cl. 345/173

(57) ABSTRACT

The system will analyze the location where contact is being made by a user on the touchpad surface, wherein the contact must be an area gesture defined as a gesture in a specific area of the touchpad along with contact that is either a single contact that is larger than a typical finger or is made by multiple contacts, wherein data from the touchpad is ignored when the area of contact begins or is only made within a corner, side, top or other region or combination of regions, wherein if an area gesture has some contact with the region, the area gesture is considered suspect and may be ignored as accidental or unintended contact.

### CROSS REFERENCE TO RELATED APPLICATIONS

This document claims priority to and incorporates by reference all of the subject matter included in the provisional patent application docket number 4619.CIRQ.PR, having Ser. No. 61/118,787.

### BACKGROUND OF THE INVENTION

1. Field Of the Invention

This invention relates generally to touchpads. More specifically, the present invention is a method of preventing accidental touching of a touch sensitive surface such as a touchpads or touch screen to be interpreted as actual data input, such as when the palm of a hand accidentally rests on a portion of the surface when performing other tasks such as typing on a keyboard or moving a touchstick pointer, trackball or mouse.

2. Description of Related Art

Hereinafter, references to a touchpad shall include all touch sensitive surfaces including touchpads and touch screens. There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

A touchpad is often placed in locations that make it easy for a user to accidentally brush the palm of a hand or a finger or thumb across a corner of a touchpad. For example, a touchpad is often placed in front of a keyboard in a laptop or other portable computing device. When the user is typing or performing some other function, the user can accidentally brush the corner of a hand across the touchpad. It would be an advantage over the prior art to be able to provide a means for ignoring accidental touching of a touchpad by recognition that this touching is accidental, and should not be interpreted as intentional input or a gesture by the user.

### BRIEF SUMMARY OF THE INVENTION

In a first embodiment of the present invention the system will analyze the location where contact is being made by a user on the touchpad surface, wherein the contact must be an area gesture defined as a gesture in a specific area of the touchpad along with contact that is either a single contact that is larger than a typical finger or is made by multiple contacts, wherein data from the touchpad is ignored when the area of contact begins or is only made within a corner, side, top or other region or combination of regions, wherein if an area gesture has some contact with the region, the area gesture is considered suspect and may be ignored as accidental or unintended contact.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

FIG. 2 is a top view of a touchpad having regions where area gestures may be ignored if the area gesture is initiated within or partially within the regions.

FIG. 3 is a top view of a touchpad having regions where area gestures may be ignored if the area gesture is initiated within or partially within the regions.

FIG. 4 is a top view of a touchpad having regions where area gestures may be ignored if the area gesture is initiated within or partially within the regions.

FIG. 5 is a top view of a touchpad having regions where area gestures may be ignored if the area gesture is initiated within or partially within the regions.

FIG. 6 is a flowchart of the steps that should be followed to determine if an area gesture should not be ignored when the option to analyze area gestures is permitted.

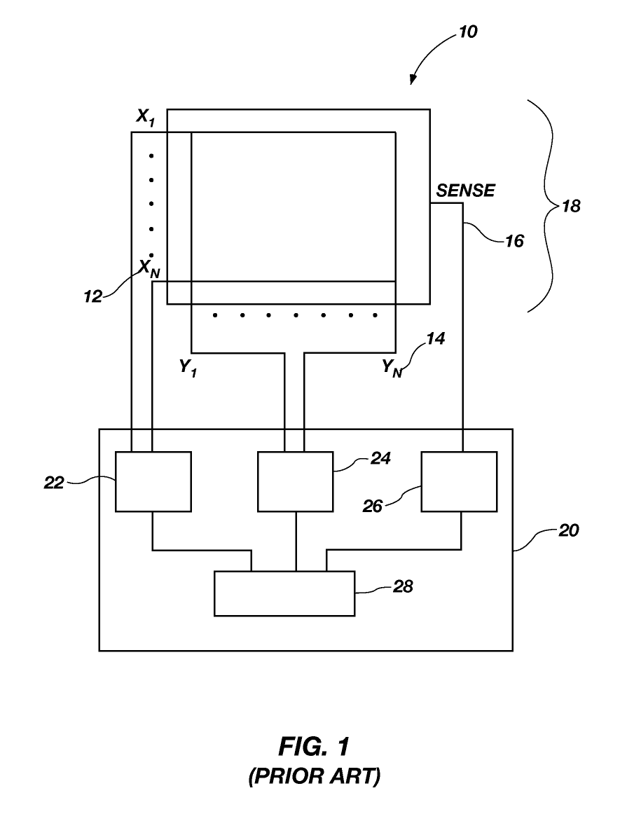

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

Using a touchpad in certain environments can be difficult because of where a touchpad is often located on or within a computing device. For example, in a laptop or other portable computing device, a touchpad is often placed in front of a keyboard. When a user is typing, a thumb or a palm of a hand just below the thumb can easily brush against a portion of the touchpad. This inadvertent touching of the touchpad can often be misinterpreted as intentional input, causing unintended data input to the portable computing device.

Unintended data input could therefore be avoided if the touchpad analyzed the nature of the object that is making contact with a touchpad, as well as the location of the contact, before allowing any contact to actually cause input from the touchpad to occur.

When accidental contact is made with the touchpad by a portion of a palm of a hand, the area of contact is generally going to be larger in area than the area of contact caused by a finger for the fact that the palm of a hand is larger than a fingertip. Contact by anything larger than a finger is defined herein as an area gesture. By limiting the analysis being performed by the touchpad to only those contacts that are being made by anything larger than a single finger, the speed of the touchpad should not be noticeably affected. Having determined that contact indicating that an area gesture is has occurred, the next step is to analyze the location of the contact with the touchpad in order to determine if valid input is actually being performed.

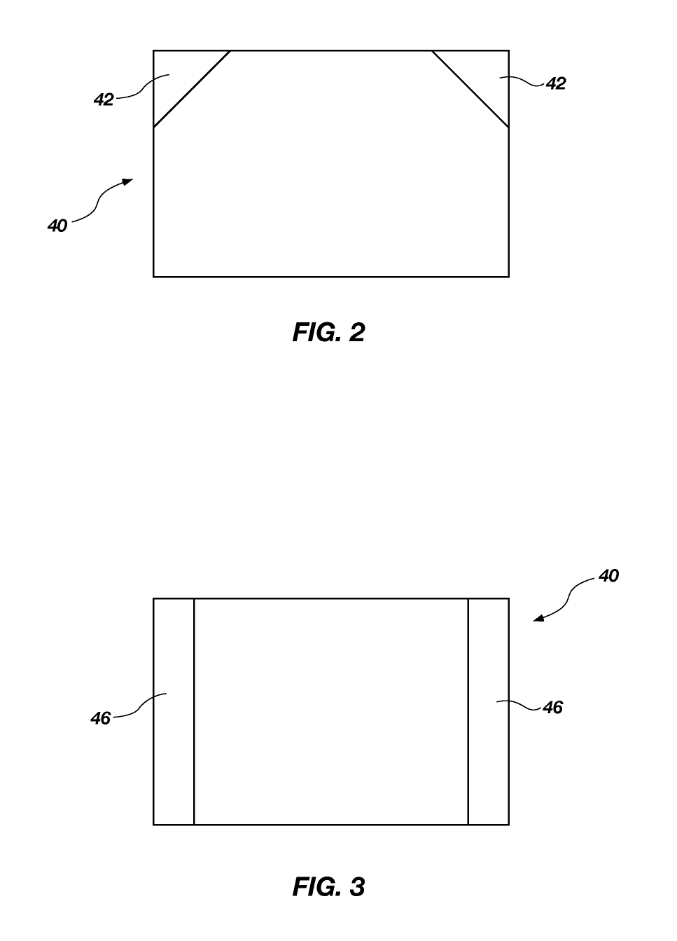

FIG. 2 shows a touchpad 40 having two corner areas 42 that may or may not be visually designated on the touchpad as having special significance. Thus, the touchpad might include a visual overlay or other indicator that shows that an area gesture in these locations may be temporarily ignored until it is determined that input is being performed. The touchpad might make the corner areas 42 distinguished visually, by a tactile distinction, or by both visual and tactile means.

Regardless, if an area gesture is detected, and the area gesture is touching any portion of the corner regions 42, then the present invention will initially ignore all input from that area gesture. The input may be ignored for a period of time, or until the area gesture is removed from the touchpad, or until the area gesture leaves the corner regions 42 and moves to another area of the touchpad 40.

The effect of the present invention is to effectively mask off certain areas of the touchpad 40 as having zones, areas or regions in which it will be assumed that if an area gesture is initiated at least partially within these areas, it will be ignored completely or until it can be analyzed to determine if the area gesture is intentional. Any area gesture beginning within these regions will be ignored, for example, until a certain condition is met, such as the area gesture moving away from the designated region.

It should be remembered that the area gesture is only being ignored when the area gesture begins completely within or partially within the boundaries of one of these regions. All area gestures that begin outside of these regions will be considered valid input, with no analysis of the area gesture to determine if it is valid.

FIG. 3 shows two regions 46 on touchpad 40 where input from an area gesture will be ignored. These regions 46 are defined as the vertical borders of the touchpad 40.

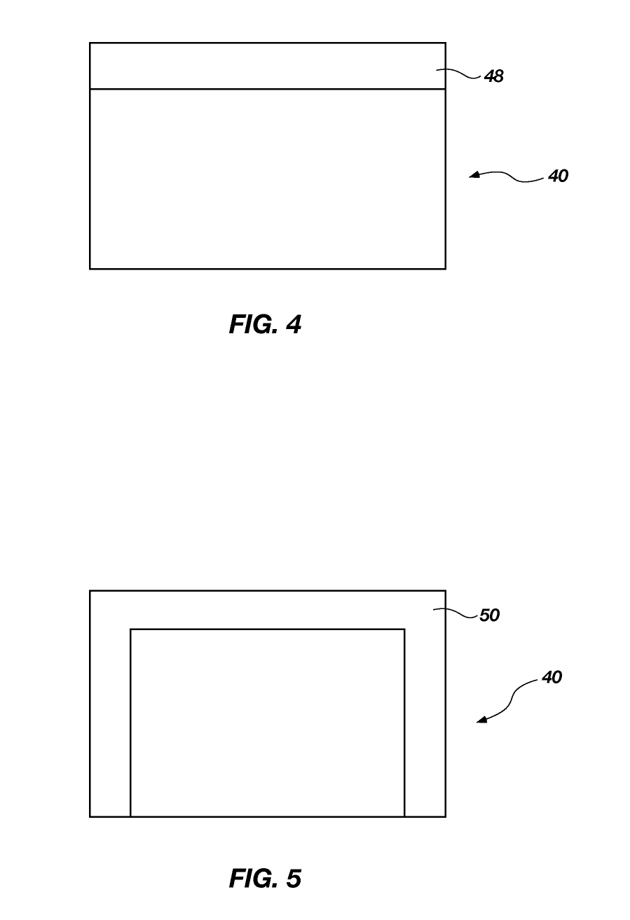

FIG. 4 shows a different region 48 on touchpad 40 where input from an area gesture will be ignored. This region 48 is defined as the horizontal top edge of touchpad 40.

FIG. 5 shows a combination of regions that form a single large region 50 where an area gesture being initiated will be ignored. The large region 50 includes the vertical edges and the horizontal top edge of touchpad 40.

What should be understood is that any region can be designated as an area where initiation of an area gesture will be ignored. The region will typically be near a border where a user is likely to accidentally brush against or rest a palm of a hand when performing tasks near a touchpad.

It should be understood that the present invention includes within its scope the possibility that that the size and shape of the zone or zones that limit area gestures can be modified. Furthermore, the system includes the possibility that the user might be allowed to change the size, shape, location and status of the area gesture limiting zones. Therefore, the present invention is not limited to the specific size, shape or location of area gesture zones shown in FIGS. 3, 4 and 5.

In another aspect of the invention, the user may find that certain actions are consistently or intermittently resulting in inadvertent area gestures. Therefore, in another alternative embodiment, the user can be allowed to customize which area gestures can be safely ignored. The user may also be able to toggle the ability to ignore area gestures on and off.

There are also essentially two different ways that an area gesture that begins within a designated gesture limiting area can be treated. The first way is to always ignore the area gesture, regardless of any time that may pass or other action that may result after the area gesture is initiated. Thus, the area gesture is never evaluated. It is always ignored, regardless of the circumstances.

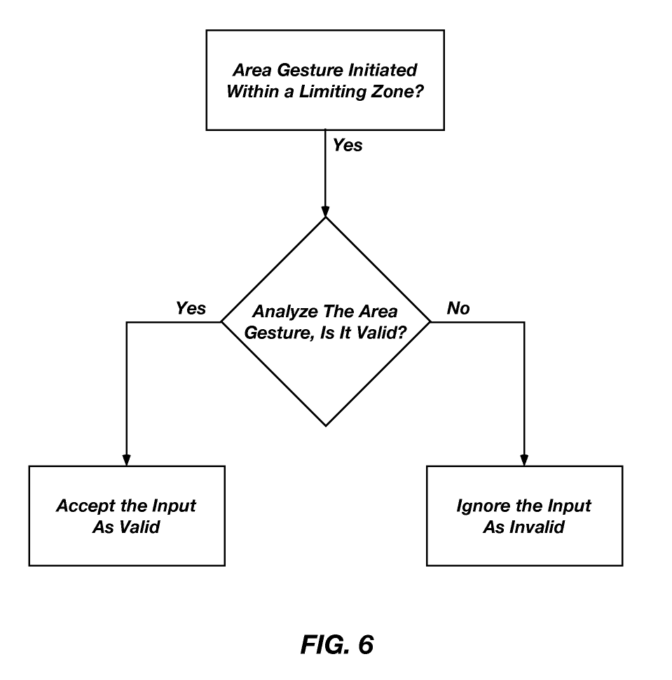

FIG. 6 illustrates the concept that the second way to handle an area gesture that begins in an area gesture limiting region is to allow some area gestures to eventually be considered valid input. This method of area gesture evaluation requires analysis of actions of the user subsequent to recognition that an area gesture might have been initiated.

Therefore, the first step 60 is to determine if an area gesture has been initiated at least partially within an area gesture limiting zone. If the area gesture is initiated outside the area gesture limiting zone, then the area gesture is automatically regarded as valid input. If initiation is at least partially within the area gesture limiting zone, then the next step 62 is to analyze the area gesture using whatever criteria are designated as allowing the area gesture to be interpreted as valid input and not disregarded as inadvertent input, and ignored.

If after analysis it is determined that the area gesture is valid, then the next step 64 is to accept the area gesture as valid and to accept the input of the area gesture as valid. However, if the area gesture is determined to be invalid because the evaluation criteria are not met, then the area gesture is disregarded as inadvertent input, and ignored.

There are numerous circumstances which can be used by the present invention to result in an area gesture to be considered valid input. These circumstances include, but should not be considered limited to, movement outside of the area gesture limiting zone, area or region, movement of the area gesture a certain distance along the surface of the touch sensitive surface, and movement that continues after a certain amount of time has elapsed since area gesture initiation. These specific circumstances should not be considered limiting. Any action of the area gesture that can be observed by the touchpad can be used as an indication that the area gesture should not be ignored, but should instead be regarded as valid input.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for reducing unintended input when an area gesture is initiated on a touch sensitive surface, said method comprising the steps of:
1) determining if an area gesture has been initiated;
2) determining if the area gesture was initiated within an area gesture limiting zone; and
3) ignoring the area gesture if the area gesture was initiated within the area gesture limiting zone.

2. A method for reducing unintended input when an area gesture is initiated on a touch sensitive surface, said method comprising the steps of:
1) determining if an area gesture has been initiated;
2) determining if the area gesture was initiated within an area gesture limiting zone;
3) analyzing the area gesture if the area gesture was initiated within the area gesture limiting zone in order to determine if the area gesture is valid; and
4) accepting the area gesture as valid if the area gesture is determined to be valid, and ignoring the area gesture if it is determined to be invalid.
